(19) United States
(12) Patent Application Publication
(10) Pub. No.: US 2022/0149668 A1
(43) Pub. Date: May 12, 2022

(54) TRANSFER MODULE AND WIRELESS POWER/DATA TRANSFER APPARATUS

(71) Applicant: PANASONIC INTELLECTUAL PROPERTY MANAGEMENT CO., LTD., Osaka (JP)

(72) Inventors: Masato MATSUMOTO, Osaka (JP); Tsutomu SAKATA, Osaka (JP); Hideaki MIYAMOTO, Osaka (JP)

(21) Appl. No.: 17/434,037

(22) PCT Filed: Dec. 16, 2019
(86) PCT No.: PCT/JP2019/049147

§ 371 Date: Aug. 26, 2021

(30) Foreign Application Priority Data
Feb. 28, 2019 (JP) 2019-036690

(51) Int. Cl. H02J 50/70; H02J 50/80; H02J 50/00; H02J 50/10; H04B 3/54; H04L 25/08

(52) U.S. Cl. CPC H02J 50/70; H02J 50/80; H04L 25/085; H02J 50/10; H04B 3/542; H02J 50/005

(57) ABSTRACT

In a system for wirelessly transmitting electric power and data, communication quality is improved. A transfer module is for use as a power transmitting module or a power receiving module in a wireless power/data transfer apparatus that wirelessly transmits electric power and data between a power transmitting module and a power receiving module. The transfer module includes: an antenna that performs power transmission or power reception via magnetic field coupling or electric field coupling; a differential transmission line pair to perform transmission or reception via electric field coupling; and a shielding part being located between the antenna and the differential transmission line pair to reduce electromagnetic interference between the antenna and the differential transmission line pair.

### TECHNICAL FIELD

The present disclosure relates to a transfer module and a wireless power/data transfer apparatus.

### BACKGROUND ART

Systems which transmit electric power wirelessly, i.e., contactlessly, and which also transmit data are known. For example, Patent Document 1 discloses an apparatus which wirelessly transmits energy and data between two objects that are capable of relative rotation with respect to each other around an axis of rotation. This apparatus includes two coils of a circular or circular arc shape that perform energy transmission, and two electrical conductors of a circular or circular arc shape that perform data transmission. The two coils are spaced apart in an opposing relationship along the axial direction of the axis of rotation, and perform energy transmission via inductive coupling. The two electrical conductors are disposed so as to be coaxial with the two coils. The electrical conductors are spaced apart in an opposing relationship along the axial direction, and perform data transmission via electrical coupling. Between the two coils and the two electrical conductors, objects for shielding purposes being made of an electrically conductive material are placed.

Patent Document 2 discloses a contactless rotary interface which perform differential signal transmission between two pairs of balanced transmission lines that are provided for two cores that are capable of making relative movements.

### CITATION LIST

### Patent Literature

[Patent Document 1] Japanese Laid-Open Patent Publication No. 2016-174149
[Patent Document 2] Japanese National Phase PCT Laid-Open Publication No. 2010-541202

### SUMMARY OF INVENTION

### Technical Problem

The present disclosure provides a technique for improving communication quality in a system for wirelessly transmitting electric power and data between two objects.

### Solution to Problem

A transfer module according to one implementation of the present disclosure is a transfer module for use as a power transmitting module or a power receiving module in a wireless power/data transfer apparatus that wirelessly transmits electric power and data between a power transmitting module and a power receiving module. The transfer module comprises: an antenna that performs power transmission or power reception via magnetic field coupling or electric field coupling; a differential transmission line pair to perform transmission or reception via electric field coupling; and a shielding part being located between the antenna and the differential transmission line pair to reduce electromagnetic interference between the antenna and the differential transmission line pair.

General or specific aspects of the present disclosure may be implemented using an apparatus, a system, a method, an integrated circuit, a computer program, or a storage medium, or any combination of an apparatus, a system, a method, an integrated circuit, a computer program, and/or a storage medium.

### Advantageous Effects of Invention

According to an embodiment of the present disclosure, communication quality can be improved in a system in which electric power and data are wirelessly transmitted between a power transmitting module and a power receiving module.

### BRIEF DESCRIPTION OF DRAWINGS

FIG. 1 is a diagram schematically showing an example of a robot arm apparatus having a plurality of movable sections.

FIG. 2 is a diagram schematically showing a wiring configuration in a conventional robot arm apparatus.

FIG. 3 is a diagram showing a specific example of the conventional configuration shown in FIG. 2.

FIG. 4 is a diagram showing an example of a robot in which power transmission in each joint is achieved wirelessly.

FIG. 5 is a diagram showing an example of a robot arm apparatus in which wireless power transmission is applied.

FIG. 6 is a cross-sectional view showing examples of a power transmitting module and a power receiving module in a wireless power/data transfer apparatus.

FIG. 7 is an upper plan view of the power transmitting module shown in FIG. 6 as viewed along an axis A.

FIG. 8 is a perspective view showing an example configuration of the magnetic core.

FIG. 9 is a cross-sectional view showing the configuration of a wireless power/data transfer apparatus according to an illustrative embodiment.

FIG. 10 is an upper plan view showing the power transmitting module in FIG. 9 as viewed along the axis A.

FIG. 11A is a diagram showing an example connection at both ends of a differential transmission line pair.

FIG. 11B is a diagram showing another example connection at both ends of a differential transmission line pair.

FIG. 11C is a diagram showing still another example connection at both ends of a differential transmission line pair.

FIG. 11D is a diagram showing a circuit element for decoding purposes.

FIG. 11E is a diagram showing an example of a communication circuit which performs both of transmission and reception.

FIG. 12 is a diagram showing enlarged a portion of the wireless power/data transfer apparatus in FIG. 9.

FIG. 13 is a diagram showing an example distribution of electric field intensity.

FIG. 14 is a diagram showing a variant of an embodiment.

FIG. 15 is a diagram showing another variant of an embodiment.

FIG. 16A is a diagram showing another example of a wireless power/data transfer apparatus.

FIG. 16B is a diagram showing still another example of a wireless power/data transfer apparatus.

FIG. 17A is a diagram showing still another variant.

FIG. 17B is an upper plan view of the power transmitting module in FIG. 17A as viewed along the axis A.

FIG. 18A is a diagram showing an example configuration where full duplex communication is possible.

FIG. 18B is an upper plan view of the power transmitting module in FIG. 18A as viewed along the axis A.

FIG. 19A is a diagram showing another example configuration where full duplex communication is possible.

FIG. 19B is an upper plan view of the power transmitting module in FIG. 19A as viewed along an axis A.

FIG. 20 is a diagram showing still another example of a wireless power/data transfer apparatus.

FIG. 21 is a block diagram showing the configuration of a system that includes a wireless power/data transfer apparatus.

FIG. 22A is a diagram showing an exemplary equivalent circuit for a transmission coil and a reception coil.

FIG. 22B is a diagram showing another exemplary equivalent circuit for a transmission coil and a reception coil.

FIG. 23A shows an example configuration of a full-bridge type inverter circuit.

FIG. 23B shows an example configuration of a half-bridge type inverter circuit.

FIG. 24 is a block diagram showing the configuration of a wireless power transmission system including two wireless power feeding units.

FIG. 25A is a diagram showing a wireless power transmission system which includes one wireless power feeding unit.

FIG. 25B is a diagram showing a wireless power transmission system which includes two wireless power feeding units.

FIG. 25C shows a wireless power transmission system which includes three or more wireless power feeding units.

### DESCRIPTION OF EMBODIMENTS

(Findings Providing the Basis of the Present Disclosure)

Prior to describing embodiments of the present disclosure, findings providing the basis of the present disclosure will be described.

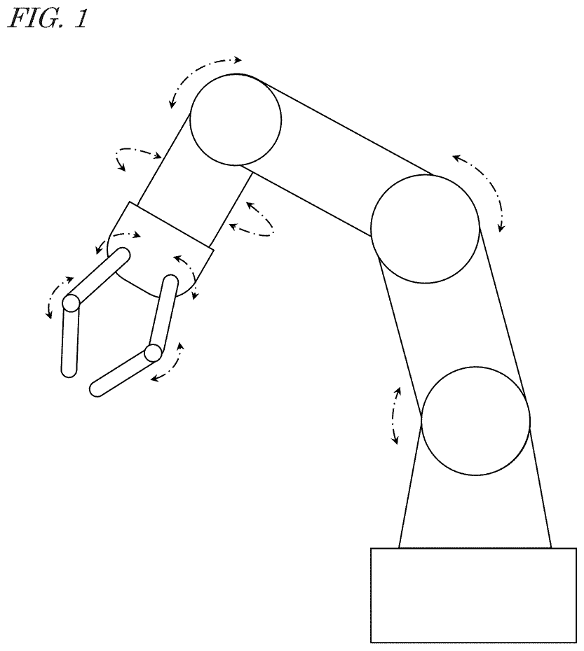

FIG. 1 is a diagram schematically showing an example of a robot arm apparatus having a plurality of movable sections (e.g., joints). Each movable section is constructed so as to be capable of rotation or expansion/contraction by means of an actuator that includes an electric motor (hereinafter simply referred to as a “motor”). In order to control such an apparatus, it is required to individually supply electric power to the plurality of motors and control them. Supply of electric power from a power supply to the plurality of motors has conventionally been achieved through connection via a large number of cables.

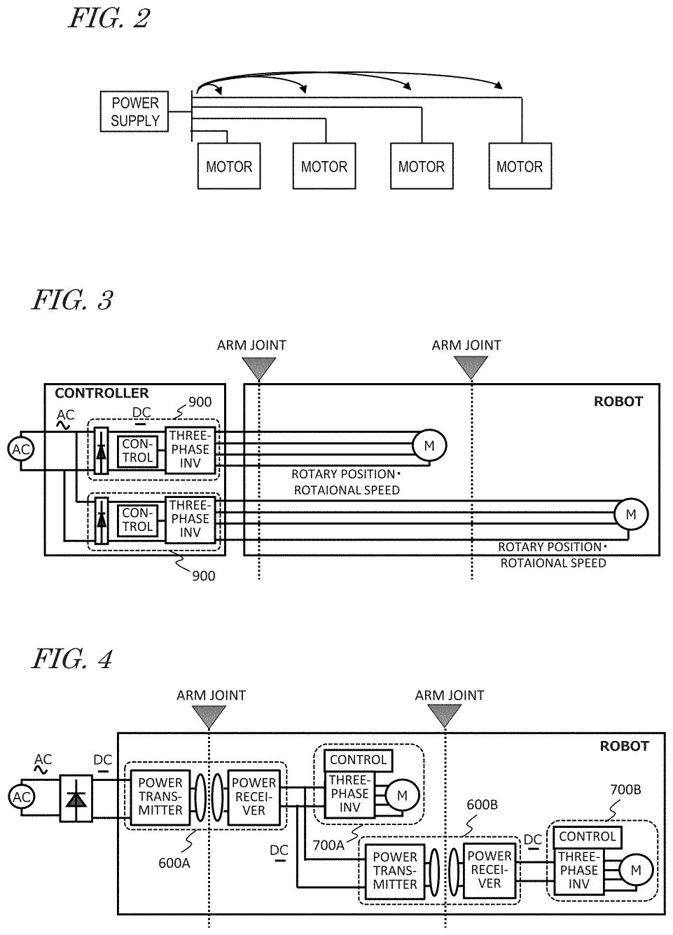

FIG. 2 is a diagram schematically showing connection between component elements in such a conventional robot arm apparatus. In the configuration shown in FIG. 2, electric power is supplied from a power supply to a plurality of motors via wired bus connections. Each motor is controlled by a control device (controller) not shown.

FIG. 3 is a diagram showing a specific example of the conventional configuration shown in FIG. 2. A robot in this example has two joints. Each joint is driven by a servo motor M. Each servo motor M is driven with a three-phase AC power. The controller includes as many motor driving circuits 900 as there are motors M to be controlled. Each motor driving circuit 900 includes a converter, a three phase inverter, and a control circuit. The converter converts alternating current (AC) power from a power supply into direct current (DC) power. The three phase inverter converts the DC power which is output from the converter into a three-phase AC power, and supplies it to the motor M. The control circuit controls the three phase inverter to supply necessary electric power to the motor M. The motor driving circuit 900 obtains information concerning rotary position and rotational speed from the motor M, and adjusts the voltage of each phase based on this information. Such a configuration allows the operation of each joint to be controlled.

However, in this configuration, a large number of cables need to be provided, as adapted to the number of motors. This causes accidents due to snagging of cables, which leads to the problems of limited ranges of motion and difficulty in changing parts. There also arises a problem in that repetitive bending of cables may deteriorate the cables, or even disrupt them. For improved safety and vibration control, there is a desire to internalize cables within the arm. Doing so would however require a large number of cables to be accommodated in the joints, which poses constraints on the automation of the production steps. Therefore, the inventors have sought to reduce the number of cables in a movable section of a robot arm by applying a wireless power transmission technology.

FIG. 4 is a diagram showing an example configuration of a robot in which power transmission in each joint is achieved wirelessly. In this example, unlike in the example of FIG. 3, a three phase inverter and a control circuit to drive each motor M are provided within the robot, rather than in an external controller. In each joint, wireless power transmission is performed by utilizing magnetic field coupling between a transmission coil and a reception coil. In each joint, this robot includes a wireless power feeding unit and a miniature motor. Each miniature motor 700A, 700B includes a motor M, a three phase inverter, and a control circuit. Each wireless power feeding unit 600A, 600B includes a power transmitting circuit, a transmission coil, a reception coil, and a power receiving circuit. The power transmitting circuit includes an inverter circuit. The power receiving circuit includes a rectifier circuit. The power transmitting circuit in the left wireless power feeding unit 600A shown in FIG. 4, which is connected between a power supply and the transmission coil, converts the supplied DC power into AC power, and supplies it to the transmission coil. The power receiving circuit converts the AC power which the reception coil has received from the transmission coil into DC power, and outputs it. The DC power which has been output from the power receiving circuit is supplied not only to the miniature motor 700A, but also the power transmitting circuit in the wireless power feeding unit 600B in any other joint. In this manner, electric power is also supplied to the miniature motors 700B driving the other joints.

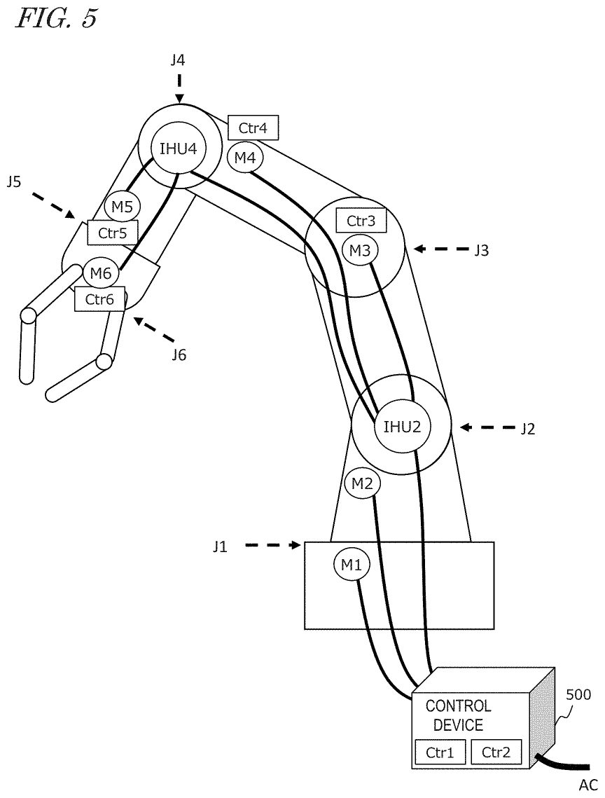

FIG. 5 is a diagram showing an example of a robot arm apparatus in which the above-described wireless power transmission is applied. This robot arm apparatus has joints J1 to J6. Among these, the above-described wireless power transmission is applied to the joints J2 and J4. On the other hand, conventional wired power transmission is applied to the joints J1, J3, J5, and J6. The robot arm apparatus includes: a plurality of motors M1 to M6 which respectively drive the joints J1 to J6; motor control circuits Ctr3 to Ctr6 which respectively control the motors M3 to M6 among the motors M1 to M6; and two wireless power feeding units (intelligent robot harness units; also referred to as IHUs) IHU2 and IHU4 which are respectively provided in the joints J2 and J4. Motor control circuits Ctr1 and Ctr2 which respectively drive the motors M1 and M2 are provided in a control device 500 which is external to the robot.

The control device 500 supplies electric power to the motors M1 and M2 and the wireless power feeding unit IHU2 in a wired manner. At the joint J2, the wireless power feeding unit IHU2 wirelessly transmits electric power via a pair of coils. The transmitted electric power is then supplied to the motors M3 and M4, the control circuits Ctr3 and Ctr4, and the wireless power feeding unit IHU4. The wireless power feeding unit IHU4 also wirelessly transmits electric power via a pair of coils in the joint J4. The transmitted electric power is supplied to the motors M5 and M6 and the control circuits Ctr5 and Ctr6. With such a configuration, cables for power transmission can be eliminated in the joints J2 and J4.

In such a system, in each wireless power feeding unit, not only power transmission but also data transmission may be performed. For example, signals for controlling each motor, or signals that are fed back from each motor, may be transmitted between a power transmitting module and a power receiving module within the wireless power feeding unit. Alternatively, in the case where a camera is mounted at the tip of the robot arm, data of images that are taken with the camera may be transmitted. In the case where a sensor is mounted at the tip, etc., of the robot arm, a group of data representing information obtained by the sensor may be transmitted

Such a wireless power feeding unit, which simultaneously performs power transmission and data transmission, will be referred to as a “wireless power/data transfer apparatus” in the present specification. In a wireless power/data transfer apparatus, it is expected to reconcile power transmission and data transmission with a high quality.

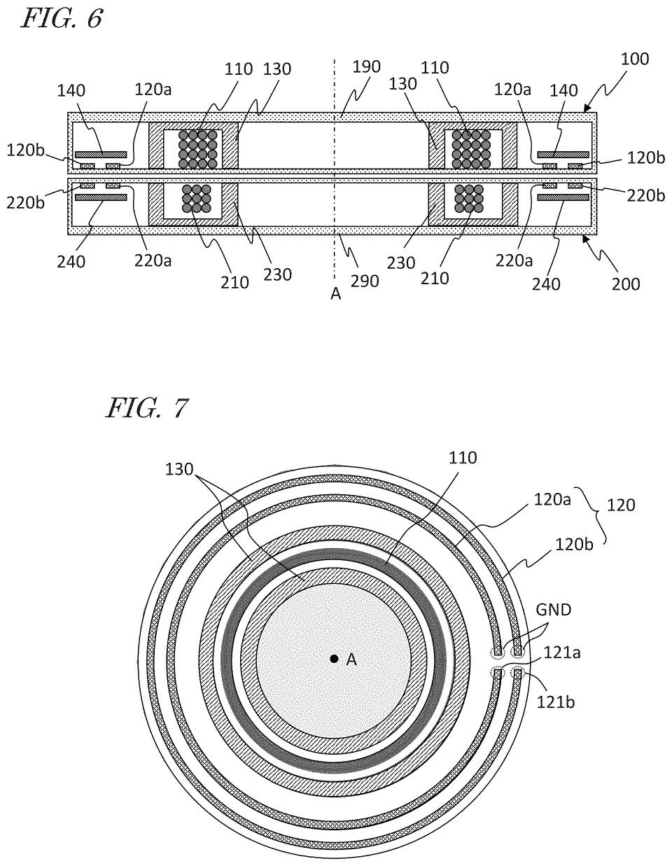

FIG. 6 is a cross-sectional view showing an example configuration of portions of a power transmitting module 100 and a power receiving module 200 of the wireless power/data transfer apparatus that perform wireless power transmission and wireless communication. FIG. 7 is an upper plan view of the power transmitting module 100 shown in FIG. 6 as viewed along an axis A. FIG. 7 illustrates an example structure of the power transmitting module 100; the power receiving module 200 also has a similar structure. At least one of the power transmitting module 100 and the power receiving module 200 can make a relative rotation around the axis A by means of an actuator not shown. The actuator may be provided on either the power transmitting module 100 and the power receiving module 200, or provided externally to them.

The power transmitting module 100 includes: a transmission coil 110; communication electrodes including two electrodes 120a and 120b functioning as differential transmission lines; a magnetic core 130; a communication circuit 140; and a housing 190 accommodating these. Hereinafter, the two electrodes 120a and 120b may be collectively referred to as “communication electrodes 120”. Moreover, two electrodes or lines functioning as differential transmission lines may be collectively referred to as a “differential transmission line pair”.

As shown in FIG. 7, the transmission coil 110 has a circular shape around the axis A. The two electrodes 120a and 120b have a circular arc shape (or a slitted circular shape) around the axis A. The two electrodes 120a and 120b adjoin one another via an interspace. The communication electrodes 120 and the transmission coil 110 are located on the same plane. On the outside of the transmission coil 110, the communication electrodes 120 is located so as to surround the transmission coil 110. The transmission coil 110 is accommodated in the magnetic core 130.

In the configuration shown in FIGS. 6 and 7, with respect to the axis A, the transmission coil 110 and the reception coil 210 are disposed on the inner side of the radius, whereas the communication electrodes 120 and 220 are disposed on the outer side of the radius. Without being limited to such a configuration, the pair consisting of the transmission coil 110 and the reception coil 210 and the communication electrodes 120 and 220 may be reversed in position. In other words, a configuration may be adopted in which the communication electrodes 120 and 220 are disposed on the inner side of the radius and in which the transmission coil 110 and the reception coil 210 are disposed on the outer side of the radius.

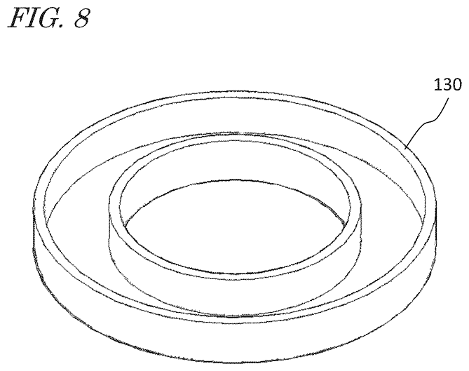

FIG. 8 is a perspective view showing an example configuration of the magnetic core 130. The magnetic core 130 shown in FIG. 8 includes an inner peripheral wall and an outer peripheral wall in a concentric arrangement, and a bottom portion connecting the two. The magnetic core 130 may not necessarily be structured so that its bottom portion is connected to the inner peripheral wall and the outer peripheral wall. The magnetic core 130 is made of a magnetic material. Between the inner peripheral wall and the outer peripheral wall of the magnetic core 130, the transmission coil 110 in a wound-around form is disposed. As shown in FIG. 7, the magnetic core 130 is disposed so that its center coincides with the axis A. The outer peripheral wall of the magnetic core 130 is located between the transmission coil 110 and the electrode 120a. As shown in FIG. 6, the magnetic core 130 is disposed so that an open portion that is opposite to its bottom is opposed to the power receiving module 200.

Input/output terminals of the communication circuit 140 are connected to one end 121a of the electrode 120a and one end 121b of the electrode 120b shown in FIG. 7. During transmission, the communication circuit 140 supplies two signals which are opposite in phase but equal in amplitude to the one end 121a of the electrode 120a and the one end 121b of the electrode 120b. During reception, the communication circuit 140 receives two signals which have been sent from the one end 121a of the electrode 120a and the one end 121b of the electrode 120b. Through differential arithmetics of the two signals, the communication circuit 140 is able to demodulate the transmitted signal. The other ends of the electrodes 120a and 120b may be connected to ground (GND), for example.

Thus, the two electrodes 120a and 120b function as differential transmission lines. Data transmission via differential transmission lines is less susceptible to electromagnetic noises. Use of differential transmission lines enables a more rapid data transmission. The communication circuit 140 may be disposed at positions opposed to the two electrodes 120a and 120b. Note that the communication circuit 140 may be disposed at positions which are different from positions opposed to the communication electrodes 120.

The transmission coil 110 is connected to a power transmitting circuit not shown. The power transmitting circuit supplies AC power to the transmission coil 110. The power transmitting circuit may include an inverter circuit to convert DC power into AC power, for example. The power transmitting circuit may include a matching circuit for impedance matching purposes. The power transmitting circuit may also include a filter circuit to suppress electromagnetic noise. A circuit board having the power transmitting circuit mounted thereon may be disposed at a position, on the opposite side from where the power receiving module 200 is located, that is adjacent to the power transmitting module 100, for example.

Except for the portion opposed to the housing 290 of the power receiving module 200, the housing 190 may be made of an electrically conductive material. The housing 190 functions to suppress leakage of an electromagnetic field to the outside of the power transmitting module 100.

The power receiving module 200 may be similar in configuration to the power transmitting module 100. The power receiving module 200 includes: a reception coil 210; a communication electrode including two electrodes 220a and 220b functioning as differential transmission lines; a magnetic core 230; a communication circuit 240; and a housing 290 accommodating these. These component elements are similar in configuration to the corresponding component elements of the power transmitting module 100. In the present specification, the two electrodes 220a and 220b may be collectively referred to as “communication electrodes 220”.

The reception coil 210, the two electrodes 220a and 220b, and the magnetic core 230 may have structures similar to the structures described in FIG. 7 and FIG. 8. The communication circuit 240 is connected to one end of each of the two electrodes 220a and 220b, to perform transmission or reception of two signals which are opposite in phase but equal in amplitude. The communication circuit 240 may be disposed in the housing 290 as shown in FIG. 6.

The reception coil 210 is opposed to the transmission coil 110. The communication electrodes 220a and 220b on the power-receiving side are respectively opposed to the communication electrodes 120a and 120b on the power-transmitting side. The transmission coil 110 and the reception coil 210 perform power transmission via magnetic field coupling. The communication electrodes 120a and 120b and the communication electrodes 220a and 220b perform data transmission via coupling between the electrodes. Data transmission may be started from either one of the power transmitting module 100 and the power receiving module 200. Note that each of the power transmitting module 100 and the power receiving module 200 may have two pairs of electrodes to function as differential transmission lines. Such a configuration will enable full duplex communication, in which transmission from the power-transmitting side to the power-receiving side and transmission from the power-receiving side to the power-transmitting side simultaneously take place. Although the transmission coil 110 and the reception coil 210 to transmit electric power via magnetic field coupling are used in the above example, a transmission electrode and a reception electrode that transmit electric power via electric field coupling may instead be used. In the present specification, the term “antenna” will be employed for a notion that encompasses any coil and any electrode used for power transmission.

With the above configuration, between the power transmitting module 100 and the power receiving module 200, electric power and data can simultaneously be transmitted wirelessly. Since differential transmission lines are used in the above configuration, influences of electromagnetic noise occurring from the power transmission section can be suppressed as compared to implementations where single-ended transmission is performed. Thus, communication quality can be improved.

However, studies by the inventors have found a problem in that, when the electric power to be transmitted is large, the communication quality of the data transmission section may lower under the influences of an intense magnetic field that is generated around the coils during power transmission. When a portion of the magnetic flux occurring from the transmission coil 110 enters into the communication electrodes 120 and 220, an electromotive force due to electromagnetic induction occurs in the communication electrodes 120 and 220. This electromotive force generates a voltage, which is unrelated to the signal for transmission, as a noise. This noise may lower the SN ratio of communications, thus degrading the communication quality.

Based on the above thoughts, the inventors have arrived at the configurations of embodiments of the present disclosure described below.

A transfer module according to one implementation of the present disclosure is a transfer module for use as a power transmitting module or a power receiving module in a wireless power/data transfer apparatus that wirelessly transmits electric power and data between a power transmitting module and a power receiving module, the transfer module including: an antenna that performs power transmission or power reception via magnetic field coupling or electric field coupling; a differential transmission line pair to perform transmission or reception via electric field coupling; and a shielding part being located between the antenna and the differential transmission line pair to reduce electromagnetic interference between the antenna and the differential transmission line pair.

In accordance with the above implementation, a shielding part is located between the antenna and the differential transmission line pair to reduce electromagnetic interference between the antenna and the differential transmission line pair. This allows for reducing influences of a magnetic flux occurring from the antenna during power transmission, such influences acting on a signal voltage in the differential transmission line pair, thereby improving communication quality.

In the present disclosure, “electromagnetic interference” means: interference due to a magnetic field; interference due to an electric field; or interference due to a combination thereof. Therefore, reducing an “electromagnetic interference” means reducing at least one of interference due to an electric field, interference due to a magnetic field, and interference due to a combination thereof.

The antenna may be a coil to perform power transmission or power reception via magnetic field coupling, or electrodes to perform power transmission or power reception via electric field coupling.

Each of the antenna and the differential transmission line pair may have an annular shape. In one implementation, the differential transmission line pair is located outside or inside the antenna. In another implementation, the differential transmission line pair is located inside the antenna. The shielding part may be a metal part having an annular shape, for example. In the following description, a metal part that functions as a shielding part will be referred to an “electrically-conductive shield”.

In addition to the aforementioned differential transmission line pair (referred to as a first differential transmission line pair), the transfer module may include a second differential transmission line pair. In that case, the first differential transmission line pair may be located outside the antenna, and the second differential transmission line pair may be located inside the antenna. Such a configuration enables full duplex communication. When full duplex communication is being performed, one of the first differential transmission line pair and the second differential transmission line pair is used for transmission of data, whereas the other of the first differential transmission line pair and the second differential transmission line pair is used for reception of data.

In addition to the aforementioned shielding part (referred to as a first shielding part), the transfer module may include a second shielding part. In that case, the first shielding part is located between the antenna and the first differential transmission line pair to reduce electromagnetic interference between the antenna and the first differential transmission line pair. The second shielding part is located between the antenna and the second differential transmission line pair to reduce electromagnetic interference between the antenna and the second differential transmission line pair. Such a configuration allows for reducing influences of a magnetic flux occurring from the antenna during power transmission, such influences acting on the signal voltages in the first differential transmission line pair and the second differential transmission line pair, thereby improving communication quality.

Each differential transmission line in the differential transmission line pair may have a first end and a second end across a gap. The first end may be an input/output end for a differential signal. The second end may be connected to ground or a resistor.

The differential transmission line pair and the antenna may be disposed on the same plane, for example. The differential transmission line pair and the antenna may be disposed on different planes. The antenna and the differential transmission line pair may be opposed to each other, with the shielding part interposed therebetween.

The power transmitting module and the power receiving module may be configured to undergo a relative movement. The power transmitting module and the power receiving module may be configured so as to be capable of relative rotation around an axis of rotation, for example. In this case, each of the antenna, the differential transmission line pair, and the shielding part may have an annular shape centered around the axis of rotation. With such a configuration, even when the power transmitting module and the power receiving module undergo a relative rotation, the antenna and the differential transmission line pair in the power transmitting module and the antenna and the differential transmission line pair in the power receiving module can be kept opposed to each other.

In the case where the antenna is a coil, a magnetic body such as the aforementioned magnetic core may be disposed between the differential transmission line pair and the coil.

The differential transmission line pair may be connected to a communication circuit. The communication circuit supplies signals in opposite in phase to the differential transmission line pair, for example.

Alternatively, the communication circuit receives signals opposite in phase which have been sent from the differential transmission line pair, and decodes them. Such a configuration allows for suppressing influences of electromagnetic noises as compared to the case where the differential transmission line pair is a single electrode.

The transfer module may further include a magnetic core located around the coil. The magnetic core may be located between the coil and the shielding part, such that an air gap exists between the magnetic core and the shielding part.

The transfer module may further include an actuator to cause a relative movement between the power transmitting module and the power receiving module. The actuator may include at least one motor. The actuator may be provided outside the transfer module.

The transfer module may further include a power transmitting circuit to supply AC power to the antenna. In this case, the transfer module functions as a power transmitting module. The power transmitting circuit may include an inverter circuit, for example. The inverter circuit may be connected to a power supply and the antenna. The inverter circuit convert DC power which is output from the power supply into AC power for transmission, and supplies it to the antenna.

The transfer module may further include a power receiving circuit to convert AC power received by the antenna into another form of electric power and output this other form of electric power. In this case, the power receiving module functions as a power receiving module. The power receiving circuit may include a power conversion circuit such as a rectifier circuit, for example. The power conversion circuit is connected between the antenna and a load. The power conversion circuit converts AC power received by the antenna into DC power or AC power as required by the load, and supplies it to the load.

The transfer module may further include a communication circuit connected to the differential transmission line pair. Two terminals of the communication circuit are connected to the differential transmission line pair. The communication circuit functions at least one of a transmission circuit and a reception circuit. During transmission, the communication circuit supplies signals which are opposite in phase to the differential transmission line pair.

A wireless power/data transfer apparatus according to another implementation of the present disclosure wirelessly transmits electric power and data between a power transmitting module and a power receiving module. The wireless power/data transfer apparatus includes the power transmitting module and the power receiving module. At least one of the power transmitting module and the power receiving module may be the transfer module according to any of the aforementioned implementations.

Both of the power transmitting module and the power receiving module may be the transfer modules according to any of the aforementioned implementations. In that case, in both of the power transmitting module and the power receiving module, influences of power transmission on communications can be reduced.

In the wireless power/data transfer apparatus, it is not necessary for the power transmitting module and the power receiving module to be identical in structure. For example, only the power transmitting module may include a shielding part, while the power receiving module may not include any shielding parts. Even such an asymmetric configuration can improve the communication quality of data transmission relative to conventional configurations.

The wireless power/data transfer apparatus may be used as a wireless power feeding unit in a robot arm apparatus as shown in FIG. 1, for example. The wireless power/data transfer apparatus is applicable to not only a robot arm apparatus, but also any apparatus that includes a rotary mechanism or a linear-motion mechanism.

In the present specification, a “load” means any device that may operate with electric power. Examples of “loads” include devices such as motors, cameras (imaging devices), light sources, secondary batteries, and electronic circuits (e.g., power conversion circuits or microcontrollers). A device which includes a load and a circuit to control the load may be referred to as a “load device”.

Hereinafter, more specific embodiments of the present disclosure will be described. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of claims. In the following description, identical or similar constituent elements are denoted by identical reference numerals.

### Embodiments

A wireless power/data transfer apparatus according to an illustrative embodiment of the present disclosure will be described. The wireless power/data transfer apparatus may be used as a component element in an industrial robot that is used at a factory, a site of engineering work, etc., as shown in FIG. 1, for example. Although the wireless power/data transfer apparatus may also be used for other purposes, e.g., supplying power to electric automobiles, the present specification will mainly describe its applications to industrial robots.

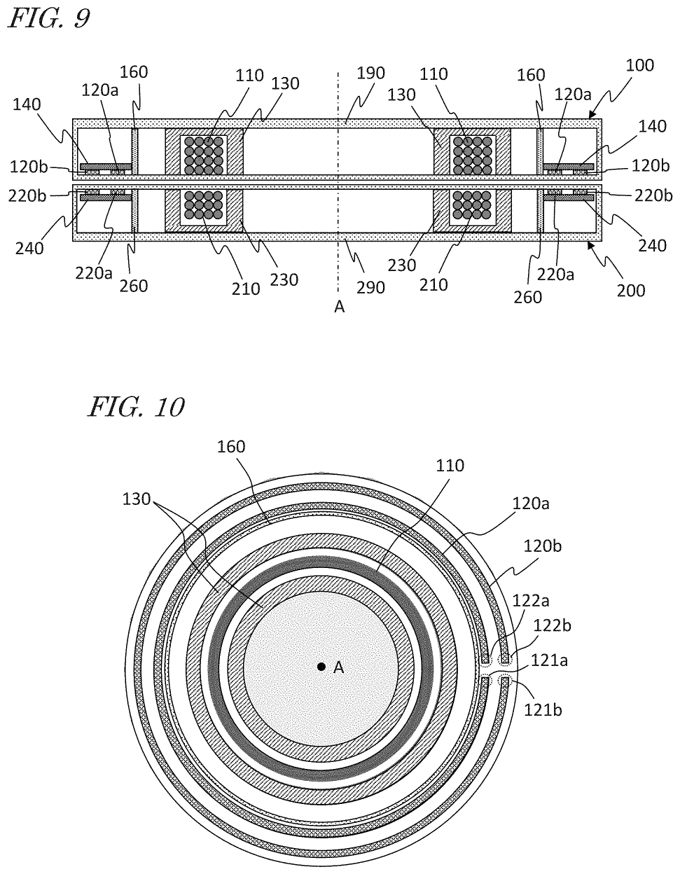

FIG. 9 is a cross-sectional view showing the configuration of a wireless power/data transfer apparatus according to the present embodiment. FIG. 10 is an upper plan view showing the power transmitting module 100 in FIG. 9 as viewed along the axis A.

The wireless power/data transfer apparatus includes the power transmitting module 100 and the power receiving module 200. The power transmitting module 100 includes an electrically-conductive shield 160 made of a metal, which is an electromagnetic shielding part, between the two electrodes 120a and 120b (which are a differential transmission line pair) and the magnetic core 130. Similarly, the power receiving module 200 includes an electrically-conductive shield 260 made of a metal, which is an electromagnetic shielding part, between the two electrodes 220a and 220b (which are a differential transmission line pair) and the magnetic core 230. Other than the electrically-conductive shields 160 and 260, this configuration is similar to the configuration shown in FIG. 6.

As shown in FIG. 10, the electrically-conductive shield 160 has an annular shape around the axis A, similarly to each of the coil 110 and the electrodes 120a and 120b. Likewise, the electrically-conductive shield 260 of the power receiving module 200 has an annular shape around the axis A, similarly to each of the coil 210 and the electrodes 220a and 220b. The radius of the annular shape of the electrically-conductive shield 160 is larger than the radius of the outer peripheral wall of the magnetic core 130, and the smaller than the radius of the inner electrode 120a. Similarly, the radius of the annular shape of the electrically-conductive shield 260 is larger than the radius of the outer peripheral wall of the magnetic core 230 and smaller than the radius of the inner electrode 220a. Each of the electrically-conductive shields 160 and 260 may have a slitted shape, i.e., a circular arc shape, as in the shapes of the communication electrodes 120 and 220. In the present disclosure, it is intended that circular arc shapes are also encompassed within “annular shapes”.

The electrode 120a has a first end 121a and a second end 122a across a gap. Also, the electrode 120b has a first end 121b and a second end 122b across a gap. The first ends 121a and 121b are input/output ends for a differential signal. In other words, input/output terminals of the communication circuit 140 are connected to the first ends 121a and 121b. On the other hand, the second end 122a and 122b are terminal ends, which are connected to ground or a resistor. The electrodes 220a and 220b of the power receiving module 200 also have a similar structure.

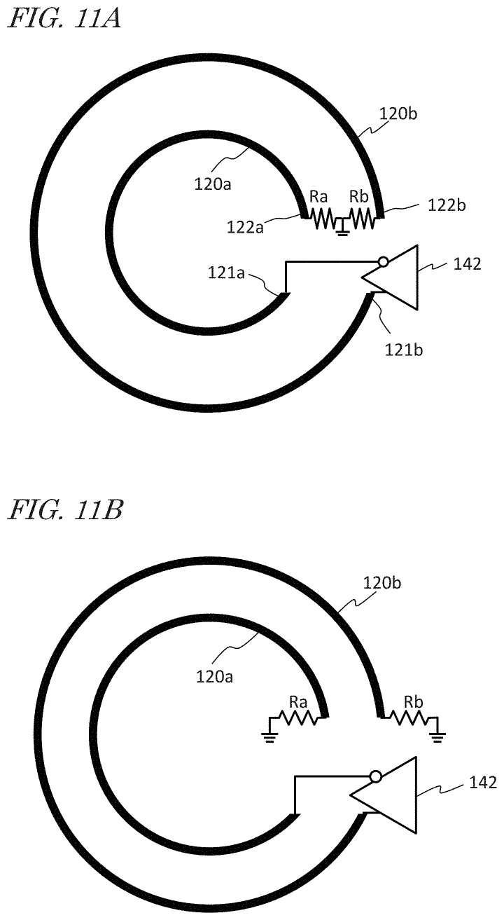

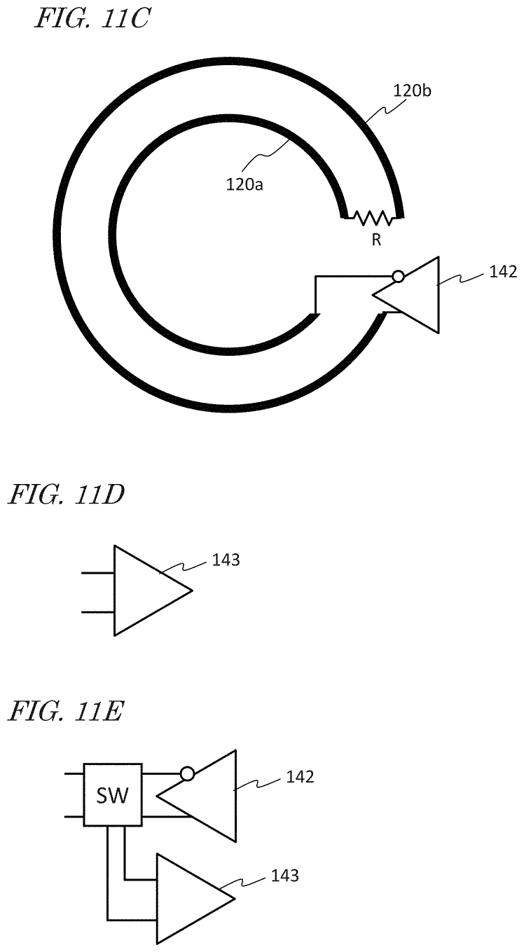

FIG. 11A is a diagram showing an example connection at both ends of the differential transmission line pair. In this example, the first end 121a of the electrode 120a and the first end 121b of the electrode 120b are connected to a differential driver 142 for transmission purposes, which is in the communication circuit 140. On the other hand, the second end 122a of the electrode 120a and the second end 122b of the electrode 120b are respectively connected to terminators Ra and Rb. The resistors Ra and Rb are connected to each other, this node being connected to ground (GND). The resistance values of the terminators Ra and Rb are set to values that will make the reflection at the terminal ends as small as possible. Thus, a configuration may be adopted where the differential lines are terminated with two resistors, a midpoint between which is grounded. With such a configuration, the termination resistance value can be set to an appropriate value for each line, whereby the potential reference for the terminal ends of the differential lines can be made common.

FIG. 11B is a diagram showing another example connection at both ends of the differential transmission line pair. In this example, the terminators Ra and Rb are individually connected to GND. Otherwise, it is similar to the example shown in FIG. 11A. In this example, too, action and effects similar to those in the example of FIG. 11A can be obtained.

FIG. 11C is a diagram showing still another example of connection at both ends of the differential transmission line pair. In this example, the second end 122a of the electrode 120a and the second end 122b of the electrode 120b are connected to one terminator Rdt. In this example, one resistor employed between the differential lines achieves termination, whereby the number of parts can be reduced.

In the examples of FIG. 11A to FIG. 11C, one end of each differential transmission line is connected to the differential driver 142, to which a signal for transmission is input. On the other hand, to those differential transmission lines for performing reception, instead of the differential driver 142 shown in FIG. 11A to FIG. 11C, a circuit element 143 for decoding purposes which is shown in FIG. 11D may be connected. Moreover, to those differential transmission lines for performing both of transmission and reception, as shown in FIG. 11E, a communication circuit that includes the differential driver 142 for transmission purposes, the circuit element 143 for reception purposes, and a switch (SW) may be connected. With such a configuration, between the power transmitting module 100 and the power receiving module 200, unidirectional or bidirectional communications can be realized.

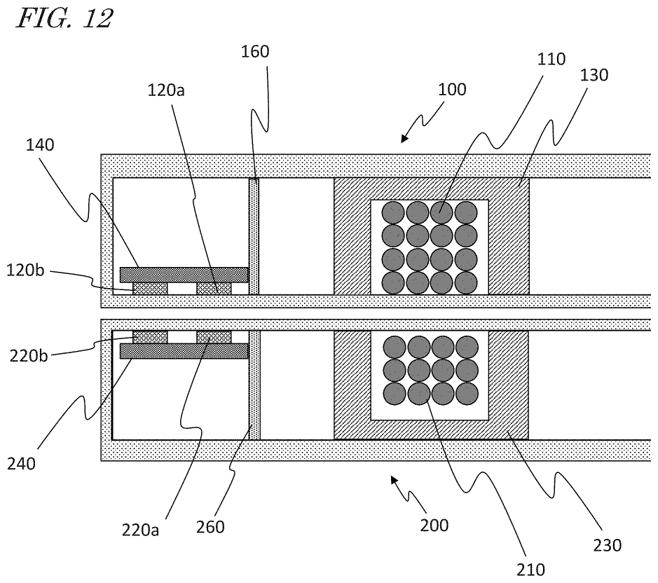

FIG. 12 is a diagram showing enlarged a portion of the wireless power/data transfer apparatus in FIG. 9. Interspaces exist between the inner electrode 120a, the electrically-conductive shield 160, and the magnetic core 130 in the power transmitting module 100. Similarly, interspaces exist between the inner electrode 220a, the electrically-conductive shield 160, and the magnetic core 130 in the power receiving module 200.

Thus, an electrically conductive part is disposed between the magnetic core 130 and the communication electrodes 120, and between the magnetic core 230 and the communication electrodes 220. Such a configuration allows for greatly reducing the noise that is contained in the signals to be exchanged during power transmission.

The inventors have performed an electromagnetic field analysis to study the effects of the present embodiment. Table 1 shows results of the analysis.

TABLE 1

| | | one conductive shield | | two conductive shields | |
|---|---|---|---|---|---|
| | | shield 1 | shield 2 | shield 1 (Al) | shield 1 (Al) |
| | no shield | (Al) only | (Al) only | & shield 2 (Al) | & shield 2 (Cu) |
| S31 [dB] | −58.2 | −73.9 | −76.2 | −90.0 | −90.4 |
| S41 [dB] | −83.3 | −91.4 | −98.8 | −93.5 | −93.5 |
| S51 [dB] | −58.5 | −74.5 | −78.1 | −96.9 | −95.7 |
| S61 [dB] | −85.0 | −96.7 | −106.8 | −94.0 | −94.0 |
| coil Q value | 1.0 | 0.90 | 0.64 | 0.63 | 0.75 |
| (normalized) | | | | | |

In this electromagnetic field analysis, passage characteristics to the respective communication electrodes 120a, 120b, 220a and 220b when supplying AC power to the transmission coil 110, as well as Q values of the transmission coil 110 and the reception coil 210, were calculated through electromagnetic field analysis. The dimensions of each part had values similar to those in an actual configuration, whereas measured values were used for electrical conductivity, material losses, and various other parameters. In Table 1, S31, S41, S51 and S61 respectively represent ratios (S parameter) of passing power to the communication electrodes 120a, 120b, 220a and 220b to the input power to the transmission coil 110.

With respect to the power transmitting module 100 and the power receiving module 200, S31, S41, S51 and S61 were calculated for the case where no electrically-conductive shield was provided and for the case where an electrically-conductive shield was provided. Within the case of providing an electrically-conductive shield, two cases were studied: the case where the distance from the communication electrodes is relatively short; and the case where the distance from the communication electrodes is relatively long. In these examples, aluminum (Al) was chosen as the material for the electrically-conductive shields. It is meant that the smaller the values of S31, S41, S51 and S61 are, the smaller the influences of the magnetic flux occurring from the transmission coil 110 on the respective communication electrodes are.

It was confirmed that, as shown in Table 1, providing an electrically-conductive shield in each module suppresses the intensity of passing power, thus improving communication quality. In particular, under the conditions of this analysis, higher improvement effects were exhibited when the electrically-conductive shield was relatively far from the communication electrodes.

Thus it was found that a configuration where an electrically-conductive shield is provided between the communication electrodes and the magnetic core in each module allows for reducing the noise (that is ascribable to the power transmission section) to be superposed on the communication signal.

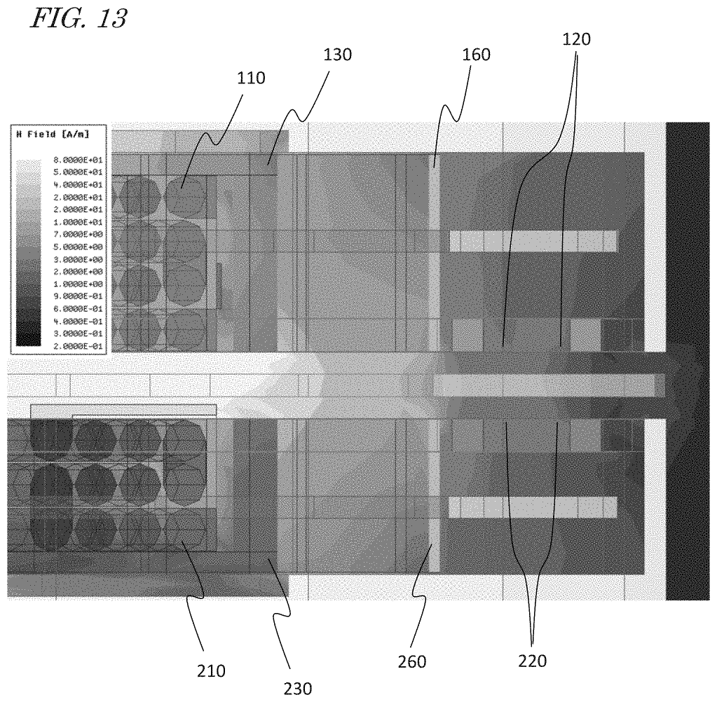

FIG. 13 is a diagram showing an example distribution of electromagnetic field intensity in the case where AC power is supplied to the transmission coil 110. In FIG. 13, the electric field intensity is higher in areas that are indicated in lighter tones. As shown in FIG. 13, providing the electrically-conductive shields 160 and 260 allows for suppressing the electromagnetic interference between the coils 110 and 210 and the communication electrodes 120 and 220.

Thus, according to the present embodiment, the electrically-conductive shield 160 is disposed between the transmission coil 110 and the communication electrodes 120, whereas the electrically-conductive shield 260 is disposed between the reception coil 210 and the communication electrodes 220. The magnetic cores 130 and 230 are disposed around the coils 110 and 210, respectively. Air gaps exist between the magnetic core 130 and the electrically-conductive shield 160 and between the magnetic core 230 and the electrically-conductive shield 160. At least a portion of the air gaps may be filled with a dielectric having any arbitrary dielectric characteristics.

With such a configuration, the intensity of the noise that is superposed from the power transmission section onto the electrodes 120a and 120b and the electrodes 220a and 220b constituting the differential transmission line pair can be suppressed. Therefore, the communication quality of data transmission, with power transmission being performed nearby, can be improved.

In the above embodiment, both the power transmitting module 100 and the power receiving module 200 include electrically-conductive shields. Without being limited to such structures, improvement effects can be obtained even when only one of the power transmitting module 100 and the power receiving module 200 includes an electrically-conductive shield.

The electrically-conductive shields do not need to be plate-shaped, but may have any shape. Each electrically-conductive shield may be made of a metal such as copper or aluminum, for example. Otherwise, the following configurations may be employed as electrically-conductive shields or alternatives thereof.

a configuration obtained by coating side walls made of an electrical insulator with an electrically conductive paint (e.g., a silver paint or a copper paint)

a configuration obtained by attaching an electrically conductive tape (e.g., a copper tape or an aluminum tape) on side walls made of an electrical insulator

an electrically conductive plastic (i.e., a material including a metal filler kneaded in a plastic)

Any of these may exhibit a similar function to that of the aforementioned electrically-conductive shield. Such configurations will collectively be referred to as “electrically-conductive shields”.

Each electrically-conductive shield according to the present embodiment has a ring structure that conforms along the transmission coil or the reception coil and the communication electrodes. Each electrically-conductive shield may have a structure with a gap to create a C shape (i.e., a circular arc shape), as does each communication electrode. In that case, too, losses of energy due to an eddy current can be reduced. The shield may have a polygonal or elliptical shape as viewed from a direction along the axis A, for example. A plurality of metal plates may be placed together to compose a shield. Furthermore, each electrically-conductive shield may have one or more apertures or slits. Such a configuration allows losses of energy due to an eddy current to be reduced.

In the present embodiment, the transmission coil or the reception coil and the communication electrode have an annular structure, and are capable of rotating against each other, with the same axis of rotation being shared by both. Along a radial direction of a circle centered around the axis of rotation, the communication electrodes are disposed outside each of the transmission coil and the reception coil. Without being limited to such a structure, the communication electrodes may be disposed inside the transmission coil and the reception coil, for example. When a shielding part is disposed between the coil and the communication electrodes, interference between them can be suppressed.

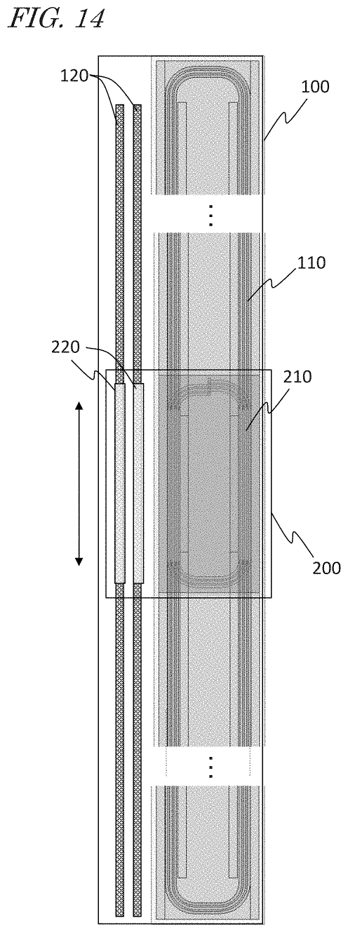

Furthermore, each coil and each communication electrode may have a shape that is not based on rotation as a prerequisite. For example, as shown in FIG. 14, each coil and each communication electrode may have a structure having a rectangular shape or an oval shape (elliptical shape) extending along a first direction (the vertical direction in FIG. 14). In that case, the transmission coil 110 and the communication electrodes 120 and the reception coil 210 and the communication electrodes 220 may be configured so as to be capable of making relative movements along the first direction by means of an actuator. In the configuration shown in FIG. 14, the reception coil 210 and the communication electrodes 220 in the power receiving module 200 are smaller than the transmission coil 110 and the communication electrodes 120 in the power transmitting module 100. Even if the power receiving module 200 moves relative to the power transmitting module 100, their opposing state is still maintained. As a result, power transmission and data transmission can be performed during movements.

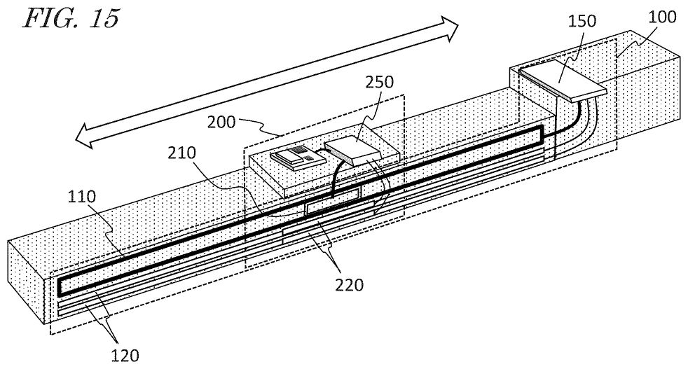

FIG. 15B is a diagram showing another example of a wireless power/data transfer apparatus. In this example, the power transmitting module 100 includes a control device 150, and the power receiving module 200 includes a control device 250. The control device 150 supplies AC power for power transmission purposes to the transmission coil 110, and supplies AC power for signal transmission purposes to the communication electrodes 120. The control device 250 in the power receiving module 200 converts the AC power received by the reception coil 210 from the transmission coil 110 into another form of electric power, and supplies it to a load device such as a motor, and demodulates a signal that is sent from the communication electrodes 220. The communication electrodes 120 are disposed adjacent to the transmission coil 110, and the communication electrodes 220 are disposed adjacent to the reception coil 210. The power receiving module 200 translates with respect to the power transmitting module 100 by means of a linear-motion mechanism such as a linear actuator.

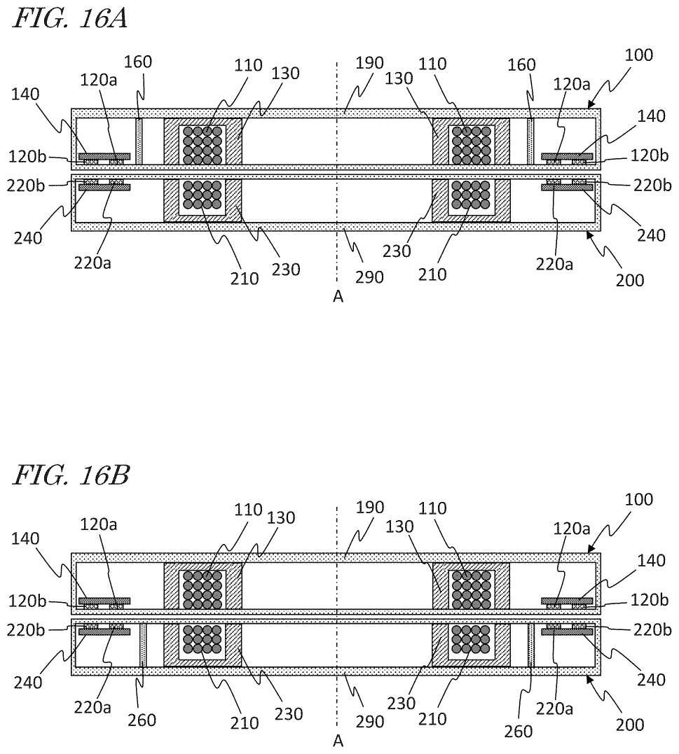

FIG. 16A and FIG. 16B are cross-sectional views showing another variant of the present embodiment. As shown in FIG. 16A, the power transmitting module 100 may include the electrically-conductive shield 160, while the power receiving module 200 may not include the electrically-conductive shield 260. Conversely, as shown in FIG. 16B, the power receiving module 200 may include the electrically-conductive shield 260, while the power transmitting module 100 may not include the electrically-conductive shield 160. Even with a configuration where only one of the power transmitting module 100 and the power receiving module 200 includes an electromagnetic shielding part, an effect of making the electromagnetic interference between the antenna and the differential transmission line pair more reduced than conventional is obtained.

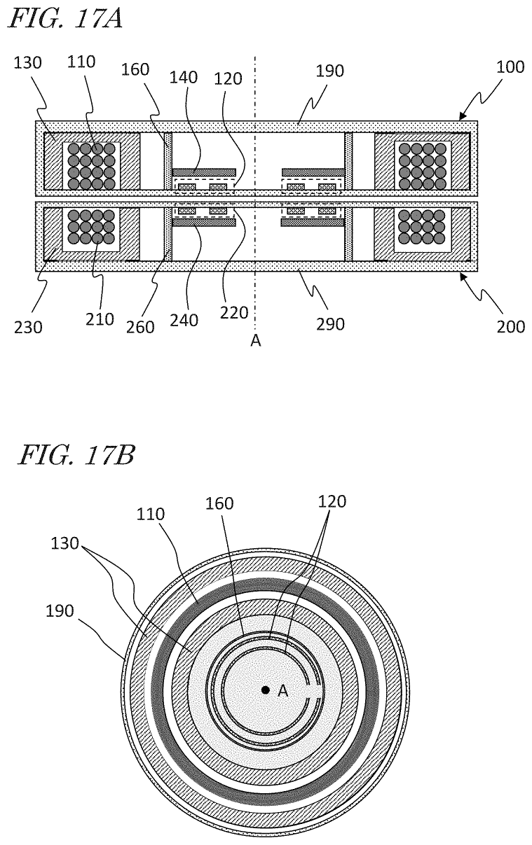

FIG. 17A is a cross-sectional view still another variant of the present embodiment. FIG. 17B is an upper plan view of the power transmitting module 100 in FIG. 17A as viewed along the axis A. FIG. 17B illustrates an example structure of the power transmitting module 100; the power receiving module 200 also has a similar structure. As shown in the figure, in this variant, the communication electrodes 120 on the power-transmitting side (i.e., the differential transmission line pair) are disposed inside the transmission coil 110 (i.e., the transmission antenna). Similarly, the communication electrodes 220 on the power-receiving side are disposed inside the reception coil 210 (i.e., the reception antenna). Between the communication electrodes 120 on the power-transmitting side and the transmission coil 110, the electrically-conductive shield 160 is disposed. Similarly, between the communication electrodes 220 on the power-receiving side and the reception coil 210, the electrically-conductive shield 260 is disposed. A configuration as in this variant, where the differential transmission line pair for communication purposes is located inside the transmission antenna or the reception antenna, also functions similarly to the above-described embodiment.

In the above embodiment, each of the power transmitting module 100 and the power receiving module 200 includes only one differential transmission line pair to function as communication electrodes. Each of the power transmitting module 100 and the power receiving module 200 may include two or more differential transmission line pairs to function as communication electrodes. Such a configuration will enable full duplex communication, in which transmission from the power transmitting module 100 to the power receiving module 200 and transmission from the power receiving module 200 to the power transmitting module 100 simultaneously take place.

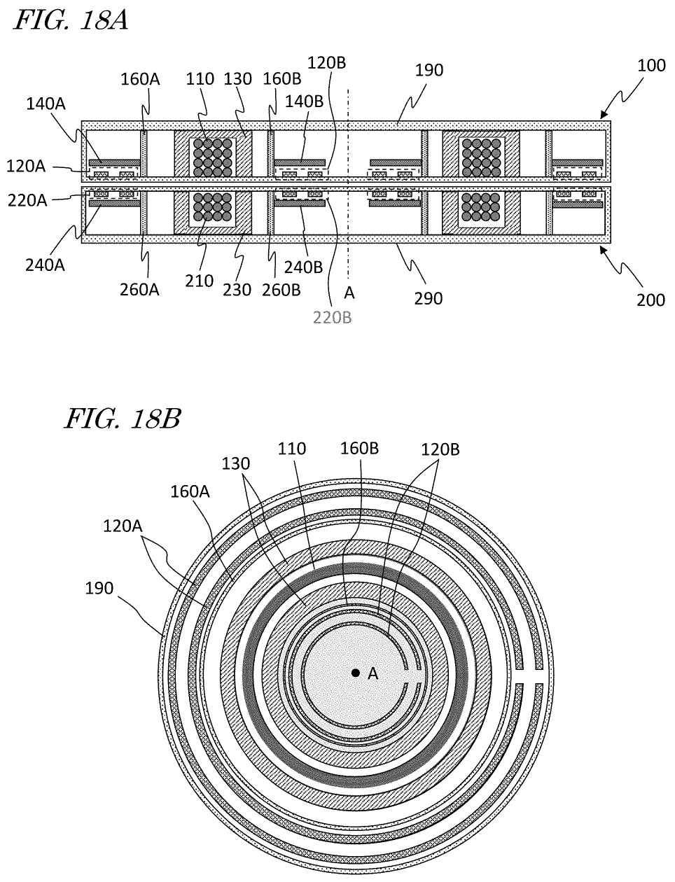

FIG. 18A and FIG. 18B show an example configuration where full duplex communication is possible. FIG. 18A is a cross-sectional view of the power transmitting module 100 and the power receiving module 200. FIG. 18B is an upper plan view of the power transmitting module 100 in FIG. 18A as viewed along the axis A. FIG. 18B illustrates an example structure of the power transmitting module 100; the power receiving module 200 also has a similar structure.

The power transmitting module 100 in this example includes first communication electrodes 120A (first differential transmission line pair), a first communication circuit 140A, a first electrically-conductive shield 160A (first shielding part), a magnetic core 130, a transmission coil 110, a second electrically-conductive shield 160B (second shielding part), and second communication electrodes 120B (second differential transmission line pair). Each of these component elements has a circular shape or a circular arc shape as viewed along the axis A. The first communication electrodes 120A are located outside the transmission coil 110, whereas the second communication electrodes 120B are located inside the transmission coil 110. First the electrically-conductive shield 160A is located between the first communication electrodes 120A and the transmission coil 110. The second electrically-conductive shield 160B is located between the transmission coil 110 and the second communication electrodes 120B. The first communication circuit 140A is connected to the first communication electrodes 120A. The second communication circuit 140B is connected to the second communication electrodes 120B. Connection between the first communication circuit 140A and the first communication electrode 120A and connection between the second communication circuit 140B and the second communication electrodes 120B are similar to the manners of connection described with reference to FIG. 11A to FIG. 11E, for example.

The power receiving module 200 is similar in structure to the power transmitting module 100. In other words, the power receiving module 200 in this example includes third communication electrodes 220A (third differential transmission line pair), a third communication circuit 240A, a third electrically-conductive shield 260A, a magnetic core 230, a reception coil 210, a third electrically-conductive shield 260B, and fourth communication electrodes 220B (fourth differential transmission line pair). Each of these component elements has a circular shape or a circular arc shape as viewed along the axis A. The third communication electrodes 220A are located outside the reception coil 210, whereas the fourth communication electrodes 220B are located inside the reception coil 210. The third electrically-conductive shield 260A is located between the third communication electrodes 220A and the reception coil 210. The fourth electrically-conductive shield 260B is located between the reception coil 210 and the fourth communication electrodes 220B. The third communication circuit 240A is connected to the third communication electrodes 220A. The fourth communication circuit 240B is connected to the fourth communication electrodes 220B. Connection between the third communication circuit 240A and the third communication electrodes 220A and connection between the fourth communication circuit 240B and the fourth communication electrodes 220B are similar to the manners of connection described with reference to 11A to FIG. 11E, for example.

Thus, because each of the power transmitting module 100 and the power receiving module 200 includes two differential transmission line pairs for communication purposes, full duplex communication can be realized. When full duplex communication is performed, one of the communication electrodes 120A and 120B in the power transmitting module 100 is used for transmission of data, whereas the other of the communication electrodes 120A and 120B is used for reception of data. At this time, one of the communication electrodes 220A and 220B in the power receiving module 200 is used for reception of data, whereas the other of the communication electrodes 220A and 220B is used for transmission of data. By taking advantage of the difference in frequency characteristics ascribable to the difference in length between the outer differential transmission line pair and the inner differential transmission line pair, different uses may be exploited depending on the speed of communication. For example, in a system where the speed of communication differs between transmission and reception, the inner differential transmission line pair may be used for relatively rapid communications, whereas the outer differential transmission line pair may be used for relatively slow communications.

As in the example shown in FIG. 18A and FIG. 18B, disposing a differential transmission line pair for communication purposes on each of the outside and the inside of the transmission coil 110 or the reception coil 210 can restrain the apparatus from increasing in size. Although a configuration might be adopted in which two differential transmission line pairs are disposed only on the outside or the inside of the coil, in that case, restraining a crosstalk between the two differential transmission line pairs would require them to be wide apart. On the other hand, in the present embodiment, a differential transmission line pair is disposed on each of the outside and the inside of the coil, and furthermore an electrically-conductive shield is provided between the coil and each differential transmission line pair. Therefore, the interval between each differential transmission line pair and the coil does not need to be excessively wide, whereby the apparatus can be restrained from increasing in size.

Note that only one of the two electrically-conductive shields may be provided in each of the power transmitting module 100 and the power receiving module 200. Moreover, the electrically-conductive shield(s) may be provided in only one of the power transmitting module 100 and the power receiving module 200.

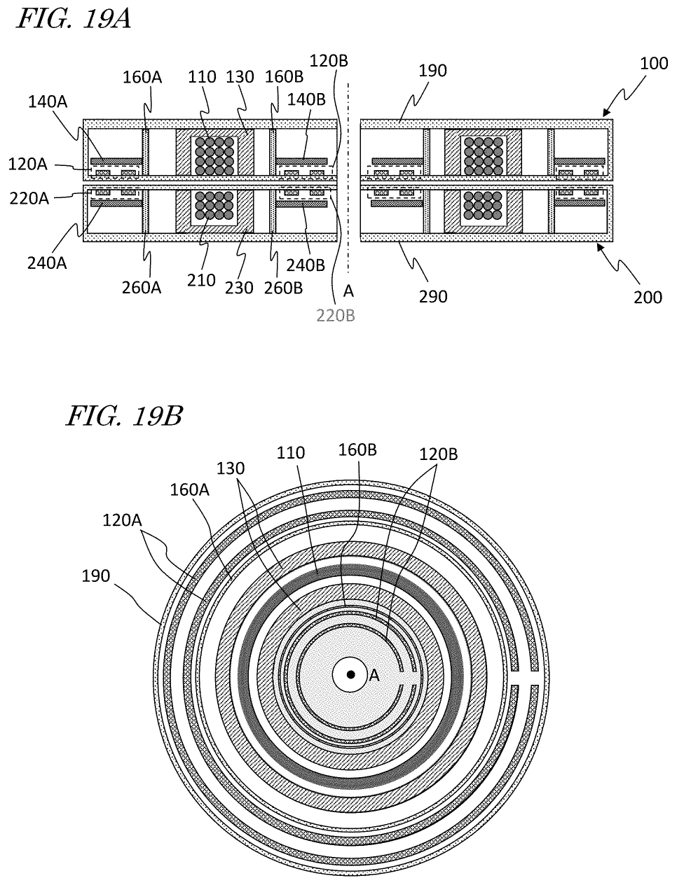

FIG. 19A and FIG. 19B are diagrams showing a variant of the embodiment shown in FIG. 18A and FIG. 18B. FIG. 19A is a cross-sectional view of the power transmitting module 100 and the power receiving module 200. FIG. 19B is an upper plan view of the power transmitting module 100 in FIG. 19A as viewed along the axis A. FIG. 19B illustrates an example structure of the power transmitting module 100; the power receiving module 200 also has a similar structure.

In this variant, each of the power transmitting module 100 and the power receiving module 200 has a cavity extending along the axis A in a central portion thereof. The wiring lines or the axis of rotation of a robot, in which the power transmitting module 100 and the power receiving module 200 are incorporated, can be passed into the cavity. Such a structure can realize a robot with a simple structure.

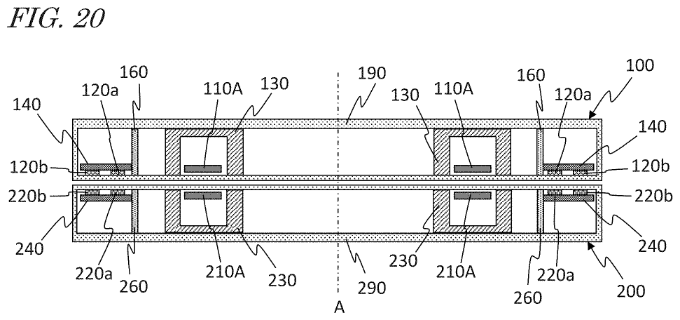

In the above embodiments, coils are used as antennas; instead of coils, however, electrodes which transmit electric power via electric field coupling (also referred to as capacitive coupling) may be used. For example, as shown in FIG. 20, the power transmitting module 100 may include a transmission electrode 110A, and the power receiving module 200 may include a reception electrode 210A. In this case, each of the transmission electrode 110A and the reception electrode 210A may be split into two subportions, such that AC voltages which are opposite in phase are applied to the two subportions. Through capacitive coupling between the transmission electrode 110A and the reception electrode 210A, electric power is wirelessly transmitted from the transmission electrode 110A to the reception electrode 210A. As in this example, in each of the above embodiments, the transmission electrode 110A and the reception electrode 210A may replace the transmission coil 110 and the reception coil 210.

Next, an example configuration of a system including the wireless power/data transfer apparatus according to the present embodiment will be described in more detail.

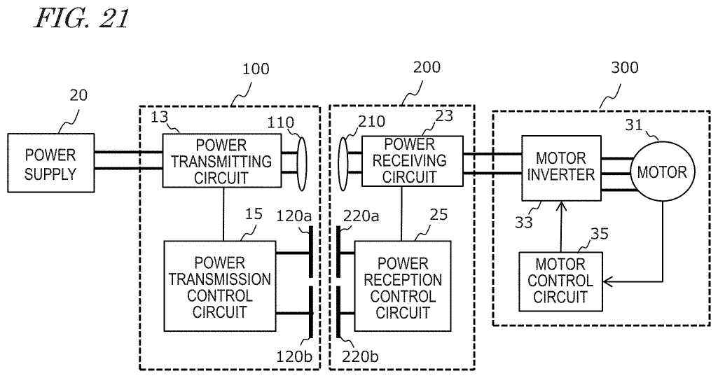

FIG. 21 is a block diagram showing the configuration of a system including the wireless power/data transfer apparatus. This system includes a power supply 20, a power transmitting module 100, a power receiving module 200, and a load 300. The load 300 in this example includes a motor 31, a motor inverter 33, and a motor control circuit 35. Without being limited to a device having the motor 31, the load 300 may be any device that operates with electric power, e.g., a battery, a lighting device, or an image sensor. The load 300 may be an electrical storage device, e.g., a secondary battery or a capacitor for electrical storage purposes, that stores electric power. The load 300 may include an actuator including the motor 31 that causes the power transmitting module 100 and the power receiving module 200 to undergo a relative movement (e.g., rotation or linear motion).

The power transmitting module 100 includes a transmission coil 110, communication electrodes 120 (electrodes 120a and 120b), a power transmitting circuit 13, and a power transmission control circuit 15. The power transmitting circuit 13, which is connected between the power supply 20 and the transmission coil 110, converts the DC power which is output from the power supply 20 into AC power, and outputs it. The transmission coil 110 sends the AC power which is output from the power transmitting circuit 13 into space. The power transmission control circuit 15 may be an integrated circuit including a microcontroller unit (MCU, hereinafter also referred to as a “micon”) and a gate driver circuit, for example. By switching the conducting/non-conducting states of the plurality of switching elements included in the power transmitting circuit 13, the power transmission control circuit 15 controls the frequency and voltage of the AC power which is output from the power transmitting circuit 13. The power transmission control circuit 15, which is connected to the electrodes 120a and 120b, also handles exchanges of signals via the electrodes 120a and 120b.

The power receiving module 200 includes a reception coil 210, communication electrodes 220 (electrodes 220a and 220b), a power receiving circuit 23, and a power reception control circuit 125. The reception coil 210 electromagnetically couples with the transmission coil 110, and receives at least a portion of the electric power which has been transmitted from the transmission coil 110. The power receiving circuit 23 includes a rectifier circuit that converts the AC power which is output from the reception coil 210 into e.g. DC power and outputs it. The power reception control circuit 25, which is connected to the electrodes 220a and 220b, also handles exchanges of signals via the electrodes 220a and 220b.

The load 300 includes the motor 31, the motor inverter 33, and the motor control circuit 35. Although the motor 31 in this example is a servo motor which is driven with a three-phase current, it may be any other kind of motor. The motor inverter 33 is a circuit that drives the motor 31, including a three-phase inverter circuit. The motor control circuit 35 is a circuit, e.g., an MCU, that controls the motor inverter 33. By switching the conducting/non-conducting states of the plurality of switching elements that are included in the motor inverter 33, the motor control circuit 35 causes the motor inverter 33 to output a three-phase AC power as desired.

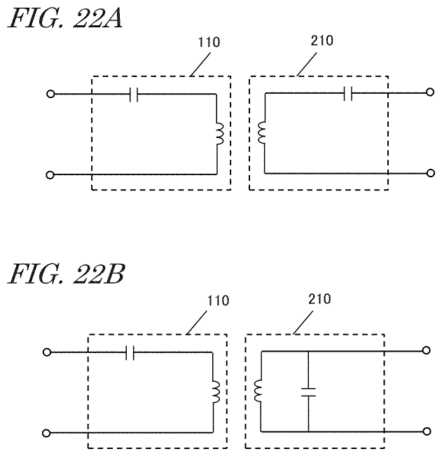

FIG. 22A is a diagram showing an exemplary equivalent circuit for the transmission coil 110 and the reception coil 210. As shown in the figure, each coil functions as a resonant circuit having an inductance component and a capacitance component. By ensuring that the resonant frequencies of two coils opposing each other have close values, electric power can be transmitted with a high efficiency. The transmission coil 110 receives AC power supplied from the power transmitting circuit 13. Owing to a magnetic field that is generated with this AC power from the transmission coil 110, electric power is transmitted to the reception coil 210. In this example, the transmission coil 110 and the reception coil 210 both function as series resonant circuits.

FIG. 22B is a diagram showing another exemplary equivalent circuit for the transmission coil 110 and the reception coil 210. In this example, the transmission coil 110 functions as a series resonant circuit, whereas the reception coil 210 functions as a parallel resonant circuit. In another possible implementation, the transmission coil 110 may constitute a parallel resonant circuit.

Each coil may be a planar coil or a laminated coil formed on a circuit board, or a wound coil in which a litz wire, a twisted wire, or the like made of a material such as copper or aluminum is used, for example. Each capacitance component in the resonant circuit may be realized by a parasitic capacitance of the coil, or a capacitor having a chip shape or a lead shape may be separately provided, for example.

The resonant frequency f0 of the resonant circuit is typically set to be equal to the transmission frequency f1 during power transmission. It is not necessary for the resonant frequency f0 of each of the resonant circuit to be exactly equal to the transmission frequency f1. The resonant frequency f0 of each may be set to a value in the range of about 50 to about 150% of the transmission frequency f1, for example. The frequency f1 of the power transmission may be e.g. 50 Hz to 300 GHz; 20 kHz to 10 GHz in one example; 20 kHz to 20 MHz in another example; and 80 kHz to 14 MHz in still another example.

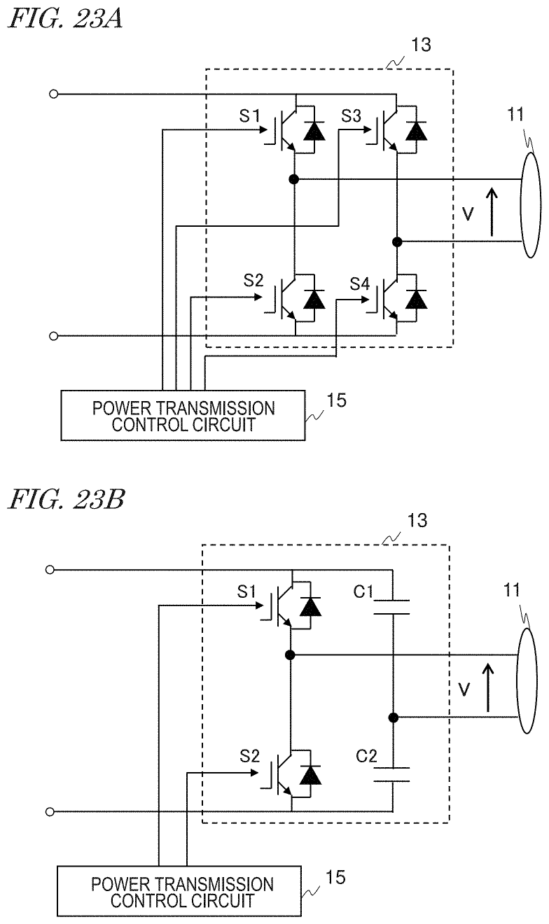

FIGS. 23A and 23B are diagrams showing exemplary configurations for the power transmitting circuit 13. FIG. 23A shows an exemplary configuration of a full-bridge type inverter circuit. In this example, by controlling ON or OFF of the four switching elements S1 to S4 included in the power transmitting circuit 13, the power transmission control circuit 15 converts input DC power into an AC power having a desired frequency f1 and voltage V (effective values). In order to realize this control, the power transmission control circuit 15 may include a gate driver circuit that supplies a control signal to each switching element. FIG. 23B shows an exemplary configuration of a half-bridge type inverter circuit. In this example, by controlling ON or OFF of the two switching elements S1 and S2 included in the power transmitting circuit 13, the power transmission control circuit 15 converts input DC power into an AC power having a desired frequency f1 and voltage V (effective values). The power transmitting circuit 13 may be different in structure from the configurations shown in FIG. 23A and FIG. 23B.

The power transmission control circuit 15, the power reception control circuit 25, and the motor control circuit 35 can be implemented as circuits including a processor and a memory, e.g., microcontroller units (MCU). By executing a computer program which is stored in the memory, various controls can be performed. The power transmission control circuit 15, the power reception control circuit 25, and the motor control circuit 35 may be implemented in special-purpose hardware that is adapted to perform the operation according to the present embodiment. The power transmission control circuit 15 and the power reception control circuit 25 also function as communication circuits. The power transmission control circuit 15 and the power reception control circuit 25 are able to transmit signals or data to each other via the communication electrodes 120 and 220.

The motor 31 may be a motor that is driven with a three-phase current, e.g., a permanent magnet synchronous motor or an induction motor, although this is not a limitation. The motor 31 may any other type of motor, such as a DC motor. In that case, instead of the motor inverter 33 (which is a three-phase inverter circuit), a motor driving circuit which is suited for the structure of the motor 31 is to be used.

The power supply 20 may be any power supply that outputs DC power. The power supply 20 may be any power supply, e.g., a mains supply, a primary battery, a secondary battery, a photovoltaic cell, a fuel cell, a USB (Universal Serial Bus) power supply, a high-capacitance capacitor (e.g., an electric double layer capacitor), or a voltage converter that is connected to a mains supply, for example.

### Other Embodiments

A wireless power transmission system according to another embodiment of the present disclosure includes a plurality of wireless power feeding units and a plurality of loads. The plurality of wireless power feeding units are connected in series, and each supply electric power to one or more loads connected thereto.

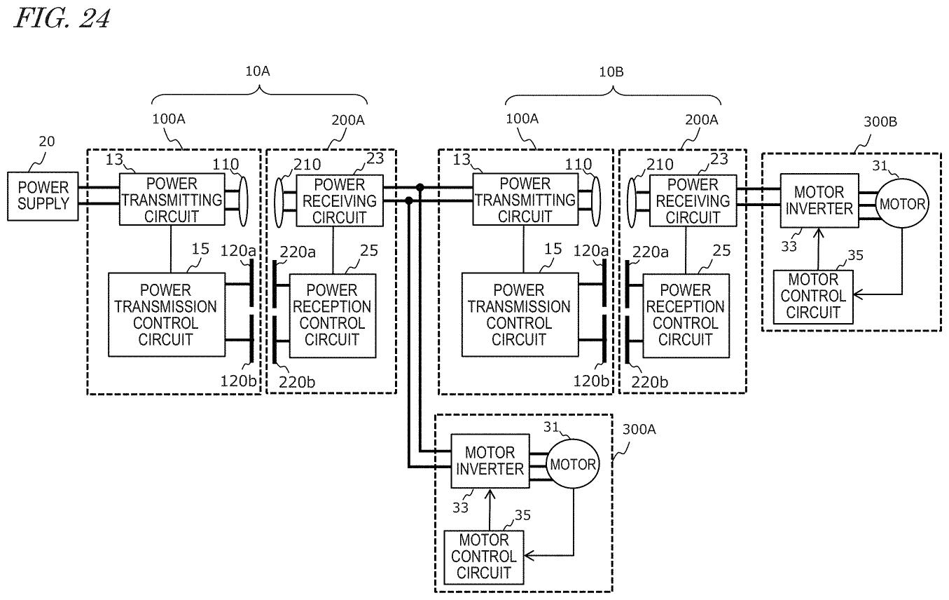

FIG. 24 is a block diagram showing the configuration of a wireless power transmission system including two wireless power feeding units. This wireless power transmission system includes two wireless power feeding units 10A and 10B and two loads 300A and 300B. The number of wireless power feeding units and the number of loads are not limited two, but may each be three or more.

Each power transmitting module 100A, 100B is similar in configuration to the power transmitting module 100 in the above-described embodiment. Each power receiving module 200A, 200B is similar in configuration to the power receiving module 200 in the above-described embodiment. The loads 300A and 300B receive electric power supplied from the power receiving modules 200A and 200B, respectively.

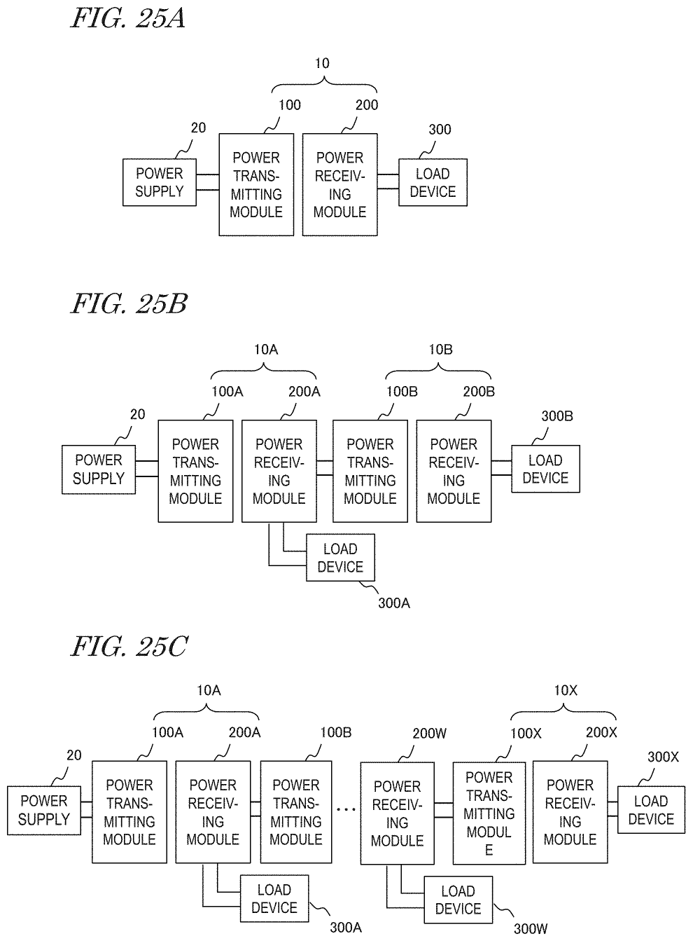

FIGS. 25A to 25C are schematic diagrams showing different types of configuration for the wireless power transmission system according to the present disclosure. FIG. 25A shows a wireless power transmission system which includes one wireless power feeding unit 10. FIG. 25B shows a wireless power transmission system in which two wireless power feeding units 10A and 10B are provided between a power supply 20 and a terminal load 300B. FIG. 25C shows a wireless power transmission system in which three or more wireless power feeding units 10A to 10X are provided between a power supply 20 and a terminal load device 300X. The technique according to the present disclosure is applicable to any of the implementations of FIGS. 25A to 25C. The configuration shown in FIG. 25C is suitably applicable to an electrically operated apparatus such as a robot having many movable sections, as has been described with reference to FIG. 1, for example.

In the configuration of FIG. 25C, the configuration according to the above-described embodiment may be applied to all of the wireless power feeding units 10A to 10X, or the above-described configuration may be applied to only some of the wireless power feeding units.

### INDUSTRIAL APPLICABILITY

The technique according to the present disclosure is suitably applicable to an electrically operated apparatus such as a robot, a monitor camera, an electric vehicle, or a multicopter to be used in a factory or a site of engineering work, for example.

### REFERENCE SIGNS LIST

10 wireless power feeding unit
13 power transmitting circuit
15 power transmission control circuit
23 power receiving circuit
31 motor
33 motor inverter
35 motor control circuit
50 power supply
100 power transmitting module
110 transmission coil
120a, 120b communication electrode
130 magnetic core
140 communication circuit
160 first electrically-conductive shield
170 second electrically-conductive shield
180 third electrically-conductive shield
190 housing
200 power receiving module
210 reception coil
220a, 220b communication electrode
230 magnetic core
240 communication circuit
260 third electrically-conductive shield
270 fourth electrically-conductive shield
280 fifth electrically-conductive shield
290 housing
300 load
500 control device
600 wireless power feeding unit
700 miniature motor
900 motor driving circuit

1. A transfer module for use as a power transmitting module or a power receiving module in a wireless power/data transfer apparatus that wirelessly transmits electric power and data between a power transmitting module and a power receiving module, the transfer module comprising:
an antenna that performs power transmission or power reception via magnetic field coupling or electric field coupling;
a differential transmission line pair to perform transmission or reception via electric field coupling; and
a shielding part being located between the antenna and the differential transmission line pair to reduce electromagnetic interference between the antenna and the differential transmission line pair.

2. The transfer module of claim 1, wherein,
each of the antenna and the differential transmission line pair has an annular shape; and
the differential transmission line pair is located outside or inside the antenna.

3. The transfer module of claim 2, wherein the differential transmission line pair is located outside the antenna.

4. The transfer module of claim 2, wherein the differential transmission line pair is located inside the antenna.

5. The transfer module of claim 2, wherein,
the differential transmission line pair is a first differential transmission line pair;
the transfer module further comprises a second differential transmission line pair;
the first differential transmission line pair is located outside the antenna; and
the second differential transmission line pair is located inside the antenna.

6. The transfer module of claim 5, wherein,
the shielding part is a first shielding part; and
the transfer module further comprises a second shielding part, the second shielding part being located between the antenna and the second differential transmission line pair to reduce electromagnetic interference between the antenna and the second differential transmission line pair.

7. The transfer module of claim 2, wherein
the shielding part is a metal part having an annular shape.

8. The transfer module of claim 2, wherein,
the power transmitting module and the power receiving module are capable of relative rotation around an axis of rotation; and
each of the antenna, the differential transmission line pair, and the shielding part is centered around the axis of rotation.

9. The transfer module of claim 2, wherein,
each differential transmission line in the differential transmission line pair has a first end and a second end across a gap;
the first end is an input/output end for a differential signal; and
the second end is connected to ground or a resistor.

10. The transfer module of claim 1, wherein the antenna is a coil.

11. The transfer module of claim 1, further comprising an actuator to cause a relative movement between the power transmitting module and the power receiving module.

12. The transfer module of claim 1, wherein,
the transfer module is the power transmitting module; and
the transfer module further comprises a power transmitting circuit to supply AC power to the antenna.

13. The transfer module of claim 1, wherein,
the transfer module is the power receiving module; and
the transfer module further comprises a power receiving circuit to convert AC power received by the antenna into another form of electric power and output the other form of electric power.

14. The transfer module of claim 1, further comprising a communication circuit connected to the differential transmission line pair.

15. A wireless power/data transfer apparatus that wirelessly transmits electric power and data between a power transmitting module and a power receiving module, comprising:
the power transmitting module; and
the power receiving module, wherein
at least one of the power transmitting module and the power receiving module is the transfer module of claim 1.
